(19) United States
(12) Patent Application Publication
(10) Pub. No.: US 2012/0140360 A1
(43) Pub. Date: Jun. 7, 2012

(54) INTEGRATED LEAD SUSPENSION (ILS) FOR USE WITH A DUAL STAGE ACTUATOR (DSA)

(76) Inventors: John Contreras, Palo Alto, CA (US); Nobumasa Nishiyama, Yokohama-city (JP); Bijan Rafizadeh, San Jose, CA (US); Eiji Soga, Sagamihara-shi (JP); Hiroyasu Tsuchida, Fujisawa (JP); Yiduo Zhang, Cupertino, CA (US)

(21) Appl. No.: 12/961,962

(22) Filed: Dec. 7, 2010

(51) Int. Cl. G11B 5/48

(52) U.S. Cl. 360/245.8; G9B/5.15

(57) ABSTRACT

Approaches for integrated lead suspension that provides many benefits, such as enabling a dual stage actuator (DSA) to be used with a single layer flex with a reduced amount of crosstalk. An integrated lead suspension comprises a tail end having a plurality of conductive pads positioned thereat. The plurality of conductive pads includes a first and second dual stage actuator (DSA) pad. The first and second DSA pads are electrically coupled to a conductive member by way of conductive vias. The conductive member may be a stainless steel island. The first DSA pad conducts a signal to a first terminal at each of a plurality of dual stage actuators, while a second terminal at each of the plurality of dual stage actuators is connected to ground.

### FIELD OF THE INVENTION

Embodiments of the invention relate to an integrated lead suspension (ILS) for use with one or more dual stage actuators (DSA) within a hard-disk drive (HDD).

### BACKGROUND OF THE INVENTION

A hard-disk drive (HDD) is a non-volatile storage device that is housed in a protective enclosure and stores digitally encoded data on one or more circular disks having magnetic surfaces. When an HDD is in operation, each magnetic-recording disk is rapidly rotated by a spindle system. Data is read from and written to a magnetic-recording disk using a read/write head which is positioned over a specific location of a disk by an actuator.

A read/write head uses a magnetic field to read data from and write data to the surface of a magnetic-recording disk. As a magnetic dipole field decreases rapidly with distance from a magnetic pole, the distance between a read/write head and the surface of a magnetic-recording disk must be tightly controlled. An actuator relies on suspension's force on the read/write head to provide the proper distance between the read/write head and the surface of the magnetic-recording disk while the magnetic-recording disk rotates. A read/write head therefore is said to “fly” over the surface of the magnetic-recording disk. When the magnetic-recording disk stops spinning, a read/write head must either “land” or be pulled away onto a mechanical landing ramp from the disk surface.

In order to achieve a higher density of data stored on a disk, it is desirable to increase the linear recording density (which refers to how many bits can be recorded in a circumferential direction on the disk) and the track density (which refers to how many tracks can be provided in a radial direction on the disk). Generally, to increase the linear recording density and the track density, the position of the read/write head needs to be known and controllable to a greater degree.

Dual actuator systems have been used to increase the accuracy of positioning the read/write head. A dual actuator system may be implemented using a suspension for a piezoelectric transducer (PZT), which is mounted on an actuator that is driven by a voice coil motor (VCM). An initial positioning action may be taken by the VCM to position the actuator, and thereafter, a finer grain positioning action may be performed with the suspension and the PZT. Conventionally, an integrated lead suspension comprises two leads (named VCM+ and VCM−) for controlling the VCM and two different leads (named DSA+ and DSA−) for driving the PZT, yielding a total of four leads in the integrated lead suspension that are involved in positioning the read/write head over the disk.

### SUMMARY OF THE INVENTION

According to one approach for an integrated lead suspension that supports a dual actuator, a piezoelectric transducer (PZT) is mounted on a suspension. Signals are transmitted from a flex mounted on the actuator to a trace on the suspension. In addition to the six wirings that are conventionally employed (Read+, Read−, Write+, Write−, TFC+, and TFC−), two further wirings (DSA+ and DSA−) are added to control the PZT. Thus, since eight wirings are required to use a dual stage actuator (such as a PZT), a total of eight pads for making an electrical connection to each of these wirings is located on the tail end of the integrated lead suspension (ILS).

Wirings are laid out in a one-to-one fashion from the preamplifiers to each head. The PZTs which are mounted on all of the actuator arms are driven by a single wiring, and so all PZTs must be connected in parallel with respect to the DSA+ and DSA− signal leads. Currently, for connection of the flex and ILS, the 90° connection mode is adopted. For this method of connection, the Read+ wiring, the Read− wiring, the Write+ wiring, the Write− wiring, the TFC+ wiring, and the TFC− wiring cross the DSA+ and DSA− wirings. If a single-layer flex is employed, then it is not possible to cross signals on the flex, which renders the implementation of the DSA using a single-layer flex difficult to impossible.

A dual layer flex allows signals to be crossed on the flex; however, dual layer flexes are expensive. Use of a dual layer flex may add 10 to 30 cents to the manufacturing cost of each hard-disk drive. As a result, the choice to use a dual layer flex instead of a single layer flex may add many millions of dollars to the manufacturing cost for a number of hard-disk drives.

FIG. 1 is an illustration of a workaround for this problem used by prior approaches. FIG. 1 depicts eight pads for making an electrical connection on the tail end of an integrated lead suspension. DSA pads 110a and 110b are used to conduct a signal to and from the dual stage actuator. As noted in FIG. 1, DSA pads 110a and 110b may be electrically connected to the dual stage actuators either by using a dual-layer flex or a trace routing. However, if trace routing is used, then the complexity of the trace routing can have severe negative implications. For example, DSA pads 110a and 110b have complicated trace routing as a necessary consequence of using a single layer flex in the prior art. The complexity of the trace routing shown in FIG. 1 has a significant negative impact on electrical performance, such as unacceptable levels of cross talk and current induction.

To overcome these and other disadvantages suffered by prior approaches, embodiments of the invention employ an integrated lead suspension that comprises a tail end having a plurality of conductive pads positioned thereon. The plurality of conductive pads includes a first and second dual stage actuator (DSA) pad. The first and second DSA pads are electrically coupled to a conductive member by way of conductive vias. The conductive member may be a stainless steel island. The first DSA pad conducts a signal to a first terminal at each of a plurality of dual stage actuators, while a second terminal at each of the plurality of dual stage actuators is connected to ground.

Since the first DSA pad and the second DSA pad are electrically coupled via a conductive island, a signal transmitted to one of the first DSA pad and the second DSA pad may be received by an arm-electronics module from the other of the first DSA pad and the second DSA pad. Thus, when a signal is conducted from an arm-electronics module to an integrated lead suspension of an embodiment, not only is the signal propagated to all dual stage actuators on the integrated lead suspension, but the signal may be propagated back to the arm-electronics module as well. The arm-electronics module in turn may propagate the signal to other integrated lead suspensions in this fashion. This allows a single signal to the used to instruct all dual stage actuators in the head-disk drive (HDD) and avoids the disadvantages suffered by prior approaches. Embodiments provide many benefits over the prior art, such as enabling a dual stage actuator (DSA) to be used with a single layer flex with a reduced amount of crosstalk.

Embodiments discussed in the Summary of the Invention section are not meant to suggest, describe, or teach all the embodiments discussed herein. Thus, embodiments of the invention may contain additional or different features than those discussed in this section.

### BRIEF DESCRIPTION OF THE DRAWINGS

Embodiments of the invention are illustrated by way of example, and not by way of limitation, in the figures of the accompanying drawings and in which like reference numerals refer to similar elements and in which:

FIG. 1 is an illustration of an approach for wiring a conductive pad at the tail end of an integrated lead suspension according to the prior art;

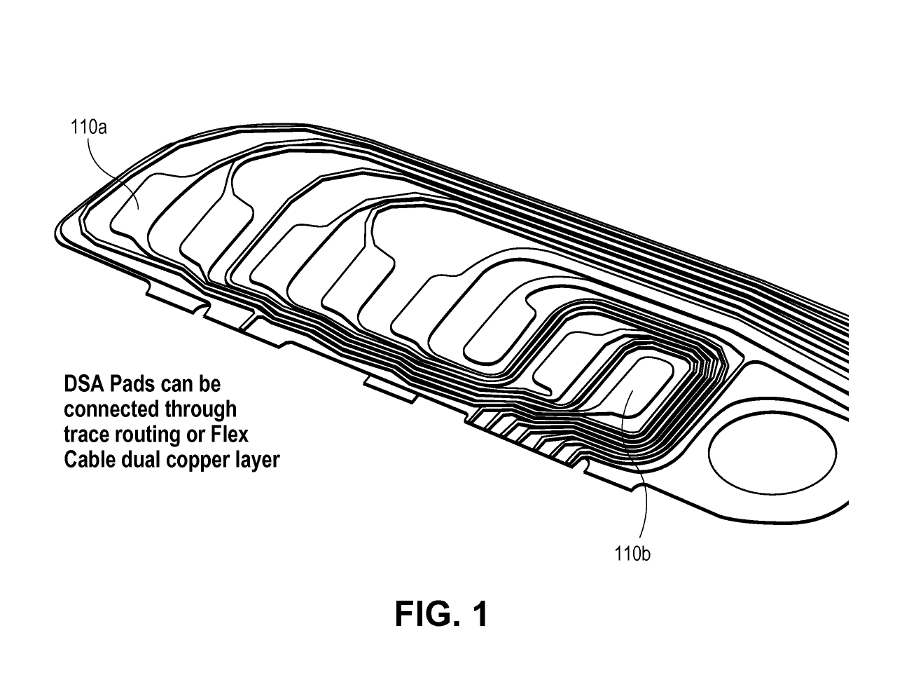

FIG. 2 is a plan view of a hard-disk drive according to an embodiment of the invention;

FIG. 3 is a plan view of a head-arm-assembly (HAA) according to an embodiment of the invention;

FIG. 4 is an illustration of an integrated lead suspension according to an embodiment of the invention;

FIG. 5 is an illustration of a top view and bottom view of the tail end of an ILS according to an embodiment of the invention;

FIG. 6 is a diagram depicting a conductive member according to an embodiment of the invention;

FIG. 7 is an illustration of the tail end of multiple integrated lead suspensions connected to an arm-electronics (AE) module according to an embodiment of the invention;

FIG. 8 is an illustration of a conductive member in one position according to an embodiment of the invention;

FIG. 9 is an illustration of a conductive member in another position according to an embodiment of the invention; and

FIG. 10 is an illustration of two exemplary positions where one or more dual stage actuators may be located according to an embodiment of the invention.

### DETAILED DESCRIPTION OF THE INVENTION

Approaches for an integrated lead suspension that enables a dual stage actuator (DSA) to be used with a single layer flex with a reduced amount of crosstalk are described. In the following description, for the purposes of explanation, numerous specific details are set forth in order to provide a thorough understanding of the embodiments of the invention described herein. It will be apparent, however, that the embodiments of the invention described herein may be practiced without these specific details. In other instances, well-known structures and devices are shown in block diagram form in order to avoid unnecessarily obscuring the embodiments of the invention described herein.

### Physical Description of Illustrative Embodiments of the Invention

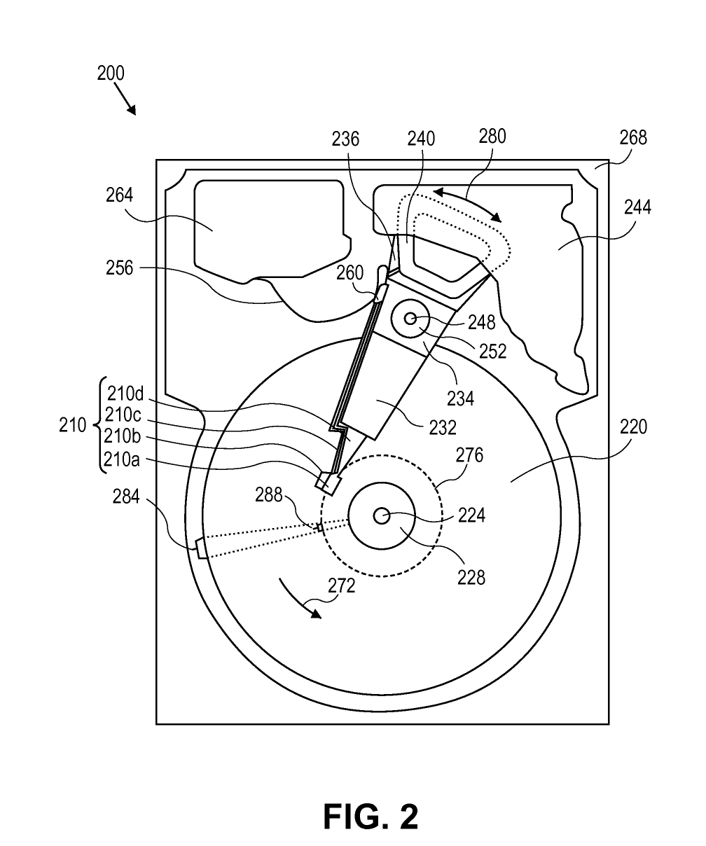

Embodiments of the invention may be implemented within a hard-disk drive (HDD). With reference to FIG. 2, in accordance with an embodiment of the present invention, a plan view of a HDD 200 in which an embodiment may be implemented is shown. FIG. 2 illustrates the functional arrangement of components of the HDD including a slider 210b including a magnetic-recording head 210a. The HDD 200 includes at least one HGA 210 including the head 210a, a lead suspension 210c attached to the head 210a, and a load beam 210d attached to the slider 210b, which includes the head 210a at a distal end of the slider 210b; the slider 210b is attached at the distal end of the load beam 210d to a gimbal portion of the load beam 210d. The HDD 200 also includes at least one magnetic-recording disk 220 rotatably mounted on a spindle 224 and a drive motor (not shown) attached to the spindle 224 for rotating the disk 220. The head 210a includes a write element, a so-called writer, and a read element, a so-called reader, for respectively writing and reading information stored on the disk 220 of the HDD 200. The disk 220 or a plurality (not shown) of disks may be affixed to the spindle 224 with a disk clamp 228. The HDD 200 further includes an arm 232 attached to the HGA 210, a carriage 234, a voice-coil motor (VCM) that includes an armature 236 including a voice coil 240 attached to the carriage 234; and a stator 244 including a voice-coil magnet (not shown); the armature 236 of the VCM is attached to the carriage 234 and is configured to move the arm 232 and the HGA 210 to access portions of the disk 220 being mounted on a pivot-shaft 248 with an interposed pivot-bearing assembly 252.

With further reference to FIG. 2, in accordance with an embodiment of the present invention, electrical signals, for example, current to the voice coil 240 of the VCM, write signal to and read signal from the PMR head 210a, are provided by a flexible cable 256. Interconnection between the flexible cable 256 and the head 210a may be provided by an arm-electronics (AE) module 260, which may have an on-board pre-amplifier for the read signal, as well as other read-channel and write-channel electronic components. The flexible cable 256 is coupled to an electrical-connector block 264, which provides electrical communication through electrical feedthroughs (not shown) provided by an HDD housing 268. The HDD housing 268, also referred to as a casting, depending upon whether the HDD housing is cast, in conjunction with an HDD cover (not shown) provides a sealed, protective enclosure for the information storage components of the HDD 200.

With further reference to FIG. 2, in accordance with an embodiment of the present invention, other electronic components (not shown), including a disk controller and servo electronics including a digital-signal processor (DSP), provide electrical signals to the drive motor, the voice coil 240 of the VCM and the head 210a of the HGA 210. The electrical signal provided to the drive motor enables the drive motor to spin providing a torque to the spindle 224 which is in turn transmitted to the disk 220 that is affixed to the spindle 224 by the disk clamp 228; as a result, the disk 220 spins in a direction 272. The spinning disk 220 creates a cushion of air that acts as an air-bearing on which the air-bearing surface (ABS) of the slider 210b rides so that the slider 210b flies above the surface of the disk 220 without making contact with a thin magnetic-recording medium of the disk 220 in which information is recorded. The electrical signal provided to the voice coil 240 of the VCM enables the head 210a of the HGA 210 to access a track 276 on which information is recorded.

Thus, the armature 236 of the VCM swings through an arc 280 which enables the HGA 210 attached to the armature 236 by the arm 232 to access various tracks on the disk 220. Information is stored on the disk 220 in a plurality of concentric tracks (not shown) arranged in sectors on the disk 220, for example, sector 284. Correspondingly, each track is composed of a plurality of sectored track portions, for example, sectored track portion 288. Each sectored track portion 288 is composed of recorded data and a header containing a servo-burst-signal pattern, for example, an ABCD-servo-burst-signal pattern, information that identifies the track 276, and error correction code information. In accessing the track 276, the read element of the head 210a of the HGA 210 reads the servo-burst-signal pattern which provides a position-error-signal (PES) to the servo electronics, which controls the electrical signal provided to the voice coil 240 of the VCM, enabling the head 210a to follow the track 276.

Upon finding the track 276 and identifying a particular sectored track portion 288, the head 210a either reads data from the track 276 or writes data to the track 276 depending on instructions received by the disk controller from an external agent, for example, a microprocessor of a computer system. Embodiments of the present invention also encompass HDD 200 that includes the HGA 210, the disk 220 rotatably mounted on the spindle 224, the arm 232 attached to the HGA 210 including the slider 210b including the head 210a.

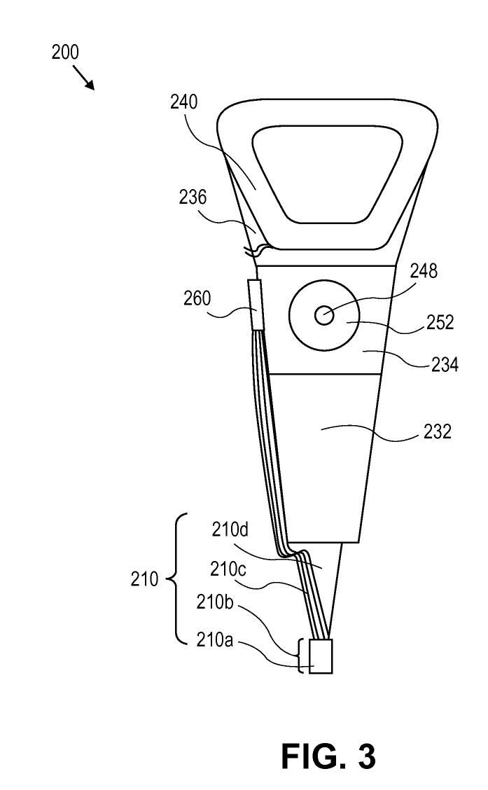

With reference now to FIG. 3, in accordance with an embodiment of the present invention, a plan view of a head-arm-assembly (HAA) including the HGA 210 is shown.

FIG. 3 illustrates the functional arrangement of the HAA with respect to the HGA 210. The HAA includes the arm 232 and HGA 210 including the slider 210b including the head 210a. The HAA is attached at the arm 232 to the carriage 234. In the case of an HDD having multiple disks, or platters as disks are sometimes referred to in the art, the carriage 234 is called an “E-block,” or comb, because the carriage is arranged to carry a ganged array of arms that gives it the appearance of a comb. As shown in FIG. 3, the armature 236 of the VCM is attached to the carriage 234 and the voice coil 240 is attached to the armature 236. The AE 160 may be attached to the carriage 234 as shown. The carriage 234 is mounted on the pivot-shaft 248 with the interposed pivot-bearing assembly 252.

Having described the operational components of a hard-disk drive (HDD), additional details about an integrated lead suspension (ILS) according to an embodiment of the invention shall now be discussed.

### Integrated Lead Suspension for Use with Dual Stage Actuators

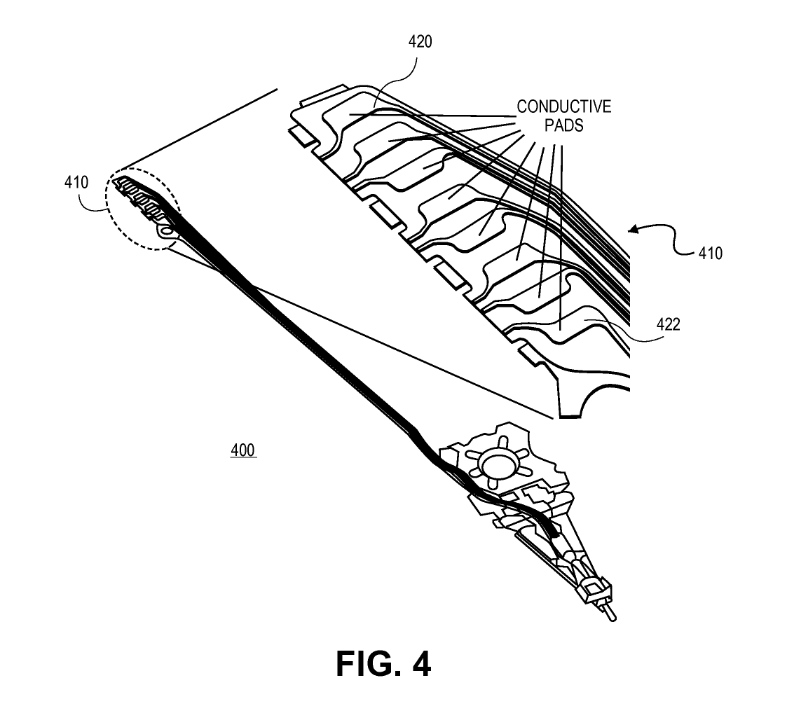

FIG. 4 is an illustration of integrated lead suspension 400 according to an embodiment of the invention. Integrated lead suspension 400 of FIG. 4 may be used to implement lead suspension 210c shown in FIGS. 2-3. As shown in FIG. 4, integrated lead suspension 400 includes tail end 410.

A magnified view of tail end 410 is also depicted in FIG. 4. The magnified view of tail end 410 shows eight conductive pads. These conductive pads are used to make an electrical connection between integrated lead suspension 400 and arm-electronics (AE) module 260 of FIG. 3. Two of the eight conductive pads in tail end 410 are responsible for conducting a signal to be propagated to one or more dual stage actuators. For example, in FIG. 4, DSA pads 420 and 422 are responsible for conducting a signal to be propagated to one or more dual stage actuators. The other six conductive pads are responsible for conducting signals associated with reading from the read/write head, writing using the read/write head, and the thermal fly-height control (TFC).

While FIG. 4 depicts DSA pads 420 and 422 as being physically located on opposite ends of tail end 410, this need not be the case, as in other embodiments, DSA pads 420 and 422 may correspond to any of the conductive pads in tail end 410.

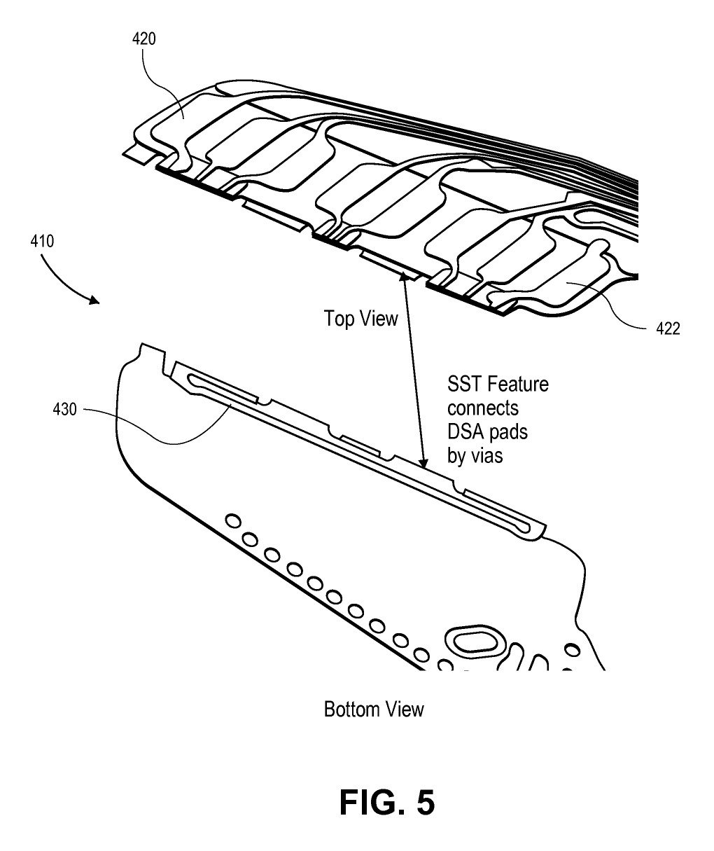

DSA pads 420 and 422 are electrically coupled to one another. To illustrate how DSA pads 420 and 422 may be electrically coupled together, consider FIG. 5, which is an illustration of a top view and bottom view of tail end 410 according to an embodiment. As shown in FIG. 5, DSA pads 420 and 422 are electrically coupled to conductive member 430 by way of conductive vias. Conductive member 430 may be implemented as a stainless steel island. Conductive member 430 may be formed to electrically connect DSA pad 420 and DSA pad 422 by etching between DSA pad 420 and DSA pad 422 so as to leave a portion of the metal (for example, stainless steel) backing layer of the ILS in island form.

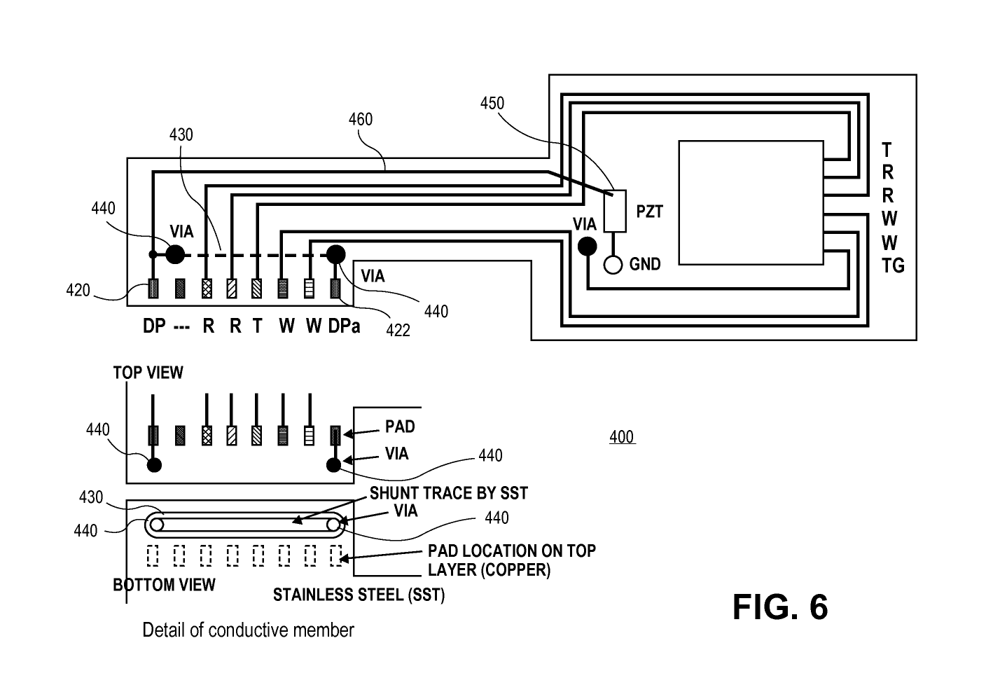

Another graphical illustration of conductive member 430 may be seen in FIG. 6, which is a diagram of conductive member 430 according to an embodiment. As shown in FIG. 6, DSA pad 420 and DSA pad 422 are electrically connected coupled to conductive member 430 by way of conductive vias 440.

As shown in FIG. 6, DSA pad 420 is electrically coupled to dual actuator 450, which is implemented using a PZT. While dual stage actuator 450 is depicted as a single dual stage actuator in FIG. 6, dual stage actuator 450 in FIG. 6 may also represent a plurality of dual stage actuators that are connected in a daisy chain wiring scheme. To illustrate, to connect three dual stage actuators in a daisy chain wiring scheme, the signal to be carried from DSA pad 420 to the three dual stage actuators over wiring 460 is branched with a first wiring (separate from conductive member 430) to a first dual stage actuator before the signal is transmitted to the final dual stage actuator, and wiring 460 is branched a second time with a second writing (separate from conductive member 430) to a second dual stage actuator before the signal is transmitted to the final dual stage actuator.

In an embodiment, as only a single signal is carried to dual stage actuator 450 (as opposed to two signals, namely DSA+ and DSA− as in the prior art), the single signal carried from one of the DSA pad 420 and DSA pad 422 may be carried through a single layer flex without incurring any additional cross talk and current induction. Embodiments of the invention need not provide a conductive path for ground voltage to dual stage actuator 450 because the other terminal of each dual stage actuator is connected to ground.

Embodiments may couple each dual stage actuator to ground using a variety of different methods. For example, in an embodiment, the suspension is electronically connected through a fixed metal element with the ground plane of the flex. The ground plane of the flex is electronically connected with the stainless steel structural material of the suspension, perhaps by screwing to the E-block via the metallic material of the arm.

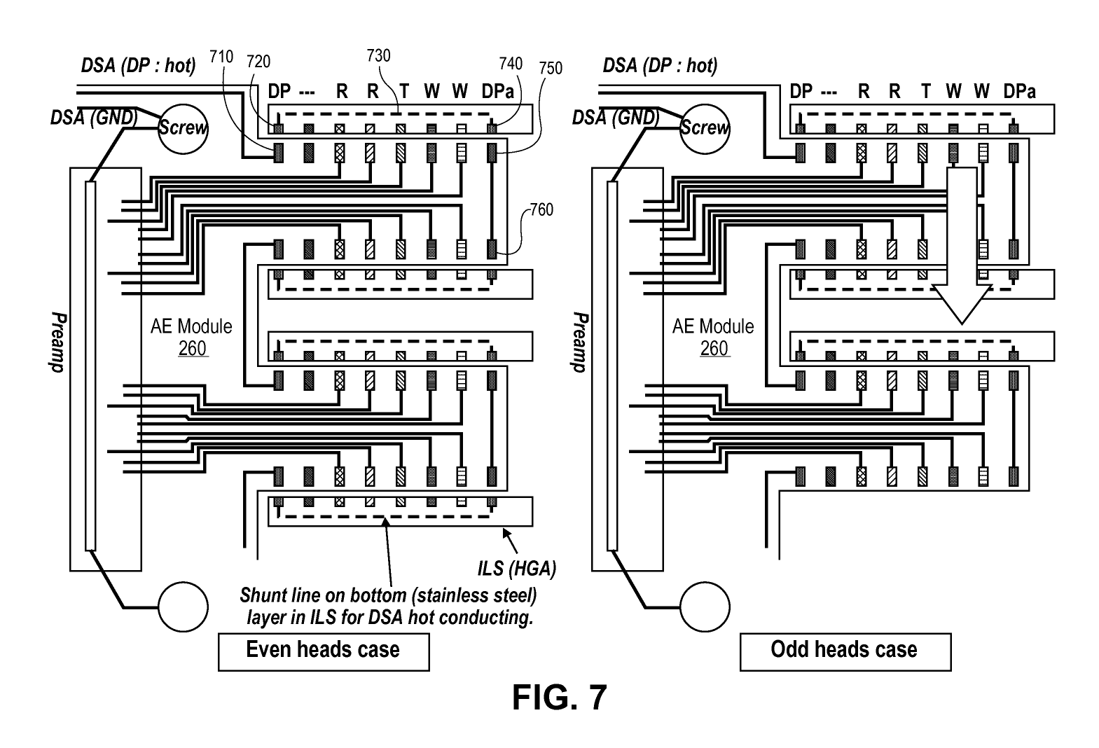

FIG. 7 is an illustration of tail end 410 of multiple integrated lead suspensions connected to arm-electronics (AE) module 260 according to an embodiment. As shown in FIG. 7, using embodiments of the invention, the crossing of the signals on a single-layer flex is avoided by AE module 260 transmitting the signal to instruct a dual stage actuator (the “DSA signal”) from conductive pad 710 to DSA pad 720 of an integrated lead suspension according to an embodiment. The DSA signal is subsequently transmitting by conductive member 730 from DSA pad 720 to DSA pad 740. Once the DSA signal is transmitted to DSA pad 740, the DSA signal is conducted back to AE module 260 at conductive pad 750. Conductive pad 750 is electrically coupled to conductive pad 760 as shown in FIG. 7. Thus, once the DSA signal is transmitted to conductive pad 760, AE module 260 may transmit the DSA signal to a different integrated lead suspension as shown in FIG. 7. In this way, the DSA signal may be transmitted, with one wiring, successively to all integrated lead suspensions in the hard-disk drive. Since the signals sent to the dual stage actuators that would otherwise need to cross are bypassed through the use of conductive member 430, the transmittal of the DSA signal to each ILS can be achieved using only a single-layer flex.

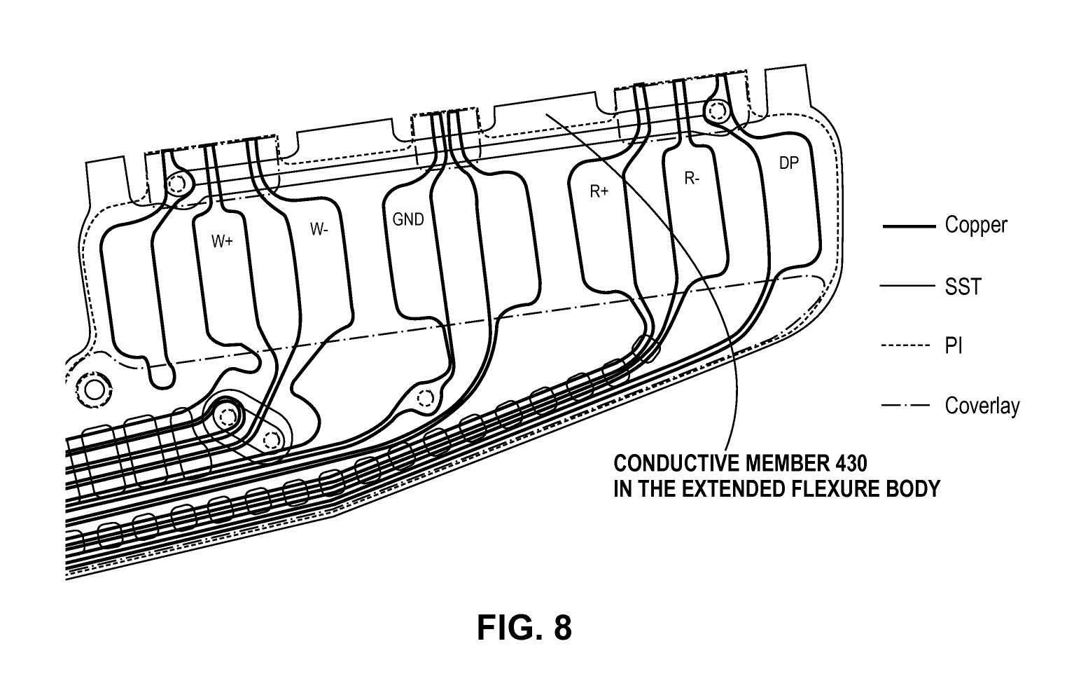

Conductive member 430 may be positioned in a variety of different locations. To illustrate, consider FIG. 8, which is an illustration of conductive member 430 in one position according to an embodiment. In FIG. 8, conductive member 430 is positioned in the extended flexure body portion of tail end 410, which is the side of tail end 410 that is physically adjacent to AE module 260.

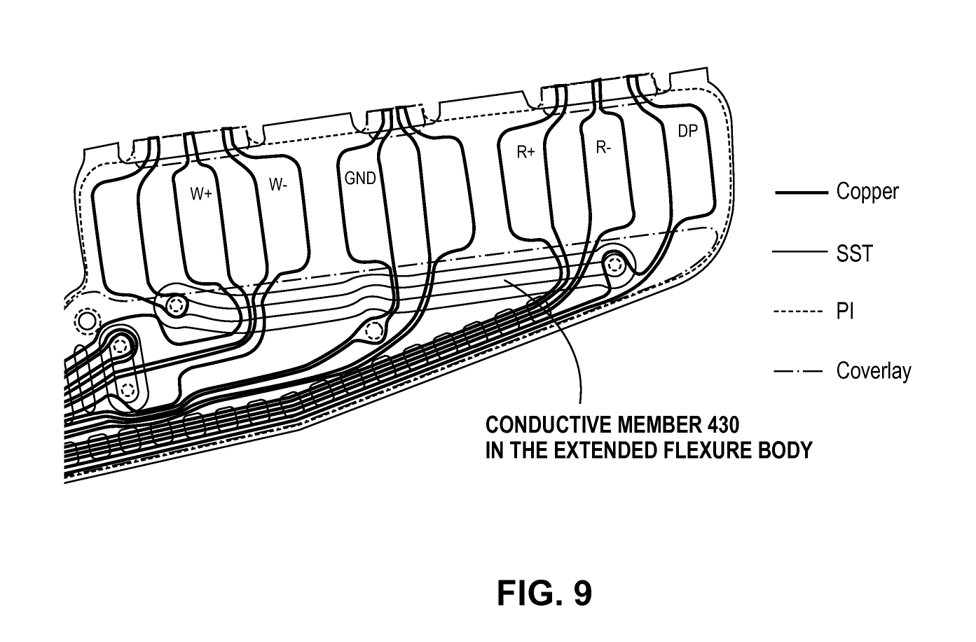

FIG. 9 is an illustration of conductive member 430 in a different position according to an embodiment. In FIG. 9, conductive member 430 is inside the flexure body at a position which is on the other side of the plurality of conductive pads than the extended flexure body portion.

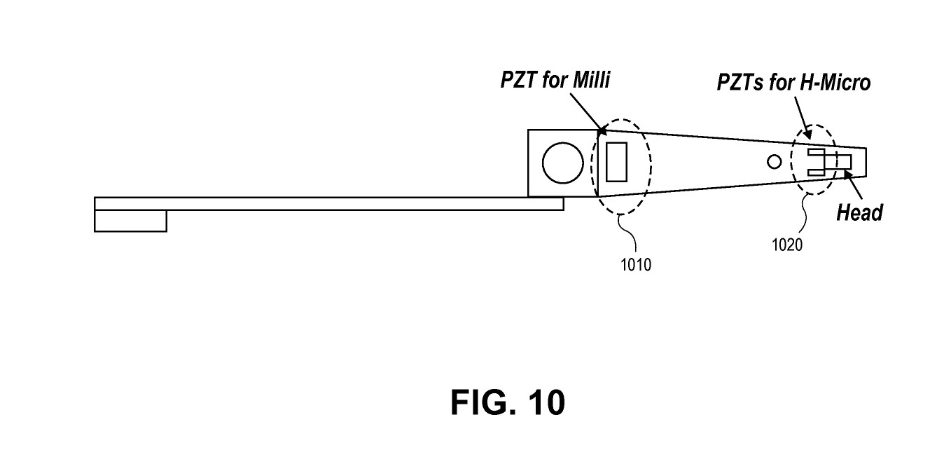

The one or more dual stage actuators mounted on a single integrated lead suspension (ILS) of an embodiment may be located at various positions or locations. To illustrate, consider FIG. 10, which is an illustration of two exemplary positions where one or more dual stage actuators may be located according to an embodiment. The one or more dual stage actuators may be located at location 1010, which is near the hinge area. Alternatively, the one or more dual stage actuators may be located at location 1020, which is near the slider area. In a typical embodiment, one or more dual stage actuators will be present in one of location 1010 and location 1020, but not in both locations. Location 1010 is more typically used when the dual stage actuator is a milli-actuator. Location 1020 is more typically used when the dual stage actuator is a micro-actuator.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. An integrated lead suspension (ILS) for a disk drive, comprising:
the integrated lead suspension (ILS) comprising a tail end, wherein positioned at the tail end is a plurality of conductive pads, and wherein the plurality of conductive pads includes a first dual stage actuator (DSA) pad and a second dual stage actuator (DSA) pad,
wherein the first DSA pad and the second DSA pad are electrically coupled to a conductive member by way of conductive vias, and
wherein the first DSA pad conducts a signal carried to a first terminal at each of a plurality of dual stage actuators, and wherein a second terminal at each of the plurality of dual stage actuators is connected to ground.

2. The integrated lead suspension (ILS) of claim 1, wherein each of the plurality of dual stage actuators is a piezoelectric transducer.

3. The integrated lead suspension (ILS) of claim 1, wherein the conductive member is a stainless steel island.

4. The integrated lead suspension (ILS) of claim 1, wherein there are eight pads in the plurality of conductive pads.

5. The integrated lead suspension (ILS) of claim 1, wherein the plurality of conductive pads are connective to a single layer flex.

6. The integrated lead suspension (ILS) of claim 1, wherein each of the plurality of dual stage actuators is located near a hinge area.

7. The integrated lead suspension (ILS) of claim 1, wherein each of the plurality of dual stage actuators is located near a slider.

8. The integrated lead suspension (ILS) of claim 1, wherein the conductive member is in the extended flexure body portion of the tail end, wherein the extended flexure body portion of the tail end is coupled to an arm-electronics module.

9. The integrated lead suspension (ILS) of claim 1, wherein the extended flexure body portion of the tail end is coupled to an arm-electronics module, and wherein the conductive member is inside the flexure body at a position which is on the other side of the plurality of conductive pads than the extended flexure body portion.

10. The integrated lead suspension (ILS) of claim 1, wherein the first DSA pad and the second DSA pad are physically located on opposite ends of the tail end of the integrated lead suspension (ILS).

11. The integrated lead suspension (ILS) of claim 1, wherein the conductive member forms a conductive signal path by which a signal is conducted to multiple integrated lead suspensions.

12. A hard-disk drive, comprising:
one or more magnetic-recording disks; and
a read/write head disposed on an integrated lead suspension (ILS), the integrated lead suspension comprising a tail end, wherein positioned at the tail end is a plurality of conductive pads, and wherein the plurality of conductive pads includes a first dual stage actuator (DSA) pad and a second dual stage actuator (DSA) pad,
wherein the first DSA pad and the second DSA pad are electrically coupled to a conductive member by way of conductive vias, and
wherein the first DSA pad conducts a signal carried to a first terminal at each of a plurality of dual stage actuators, and wherein a second terminal at each of the plurality of dual stage actuators is connected to ground.

13. The hard-disk drive of claim 12, wherein each of the plurality of dual stage actuators is a piezoelectric transducer.

14. The hard-disk drive of claim 12, wherein the conductive member is a stainless steel island.

15. The hard-disk drive of claim 12, wherein there are eight pads in the plurality of conductive pads.

16. The hard-disk drive of claim 12, wherein the plurality of conductive pads are connective to a single layer flex.

17. The hard-disk drive of claim 12, wherein each of the plurality of dual stage actuators is located near a hinge area.

18. The hard-disk drive of claim 12, wherein each of the plurality of dual stage actuators is located near a slider.

19. The hard-disk drive of claim 12, wherein the conductive member is in the extended flexure body portion of the tail end, wherein the extended flexure body portion of the tail end is coupled to an arm-electronics module.

20. The hard-disk drive of claim 12, wherein the extended flexure body portion of the tail end is coupled to an arm-electronics module, and wherein the conductive member is inside the flexure body at a position which is on the other side of the plurality of conductive pads than the extended flexure body portion.
